(19) United States
(12) Patent Application Publication
(10) Pub. No.: US 2006/0019124 A1
(43) Pub. Date: Jan. 26, 2006

(54) Perpendicular magnetic recording medium and magnetic recording apparatus

(76) Inventors: Tomio Iwasaki, Tsukuba (JP); Yuzuru Hosoe, Hino (JP)

Correspondence Address: MCDERMOTT WILL & EMERY LLP, 600 13TH STREET, N.W., WASHINGTON, DC, 20005-3096, US

(21) Appl. No.: 11/186,931

(22) Filed: Jul. 22, 2005

(30) Foreign Application Priority Data
Jul. 23, 2004 (JP) 2004-215094

(51) Int. Cl. G11B 5/66

(52) U.S. Cl. 428/832

(57) ABSTRACT

A perpendicular magnetic recording medium, comprises: a substrate; a soft-magnetic underground layer formed on one main surface of the substrate; a non-magnetic layer formed on the soft-magnetic underground layer; an intermediate layer formed on the non-magnetic layer; and a perpendicular recording layer formed on the intermediate layer, wherein an addition element is contained within the intermediate layer, for improving flatness of the surface thereof, thereby having high reliability and high functions, as well as, a magnetic recording apparatus having high reliability and high performances.

### BACKGROUND OF THE INVENTION

The present invention relates to a perpendicular magnetic recording medium and a magnetic recording apparatus.

In a filed of magnetic disks, in particular, when applying the conventional internal surface recording method, there is a problem that the data recorded thereon disappears or is deleted due to ill influences of heats, accompanying with an increase of an area recoding density. On the contrary to this, in case of applying the perpendicular recording method therein, as is described in the following Patent Document 1, for example, an anti-magnetic field is reduced between bits neighboring with each other, accompanying with an increase of the recording density; therefore, the data recorded can be held with stability.

Patent Document 1: Japanese Patent Laying-Open No. 2004-39152 (2004)

However, within a perpendicular magnetic recording medium, which comprises a substrate, a soft-magnetic underground layer formed on one of main surfaces of said substrate, a non-magnetic layer formed in contact with the said soft-magnetic underground layer, an intermediate layer formed in contact with said non-magnetic layer, and a perpendicular recording layer formed in contact with said intermediate layer, and in particular. In case when the intermediate layer is made from a film of Ru, it is found that the sufficient flatness cannot be obtained upon the surface when forming the Ru film thereon. Then, if forming the perpendicular recording layer or film on that intermediate layer, the boundary surface is roughen in the condition thereof, between the intermediate layer and the perpendicular recording layer, and it results into a probability of lowering the reliability and performances of the product.

### BRIEF SUMMARY OF THE INVENTION

A first object, according to the present invention, is to provide a perpendicular magnetic recording medium having high reliability. A second object, according to the present invention, is to provide a perpendicular magnetic recording medium having high performances. Also, a third object, according to the present invention, is to provide a magnetic recording apparatus having high reliability. And, a fourth object, according to the present invention, is to provide a magnetic recording apparatus having high performances.

The inventors of the present invention found that grain boundary grooves are formed due to an ill balancing between the grain boundary diffusion and the surface diffusion, in particular, within the perpendicular magnetic recording medium, which comprises the substrate, the soft-magnetic underground layer formed on one of main surfaces of said substrate, the non-magnetic layer formed in contact with said soft-magnetic underground layer, the intermediate layer formed in contact with said non-magnetic layer, and the perpendicular recording layer formed in contact with said intermediate layer, and in particular, in the case when the intermediate layer is made from the Ru film. Due to such the grain boundary grooves, the magnetic recording mediumresults into ill flatness on the surf ace thereof. Then, as a result of conducting intensive researches and/or studies thereof, the inventors found out that an addition of Ti into the Ru film is effective, as a means for increasing the flatness on the surface thereof. Further, the inventors found out that an addition of Al into a Cu film, in the case when the intermediate film is made from a Cu film.

Those objects according to the present invention, are accomplished by a perpendicular magnetic recording medium and a magnetic recording apparatus, which comprise the following constituent elements:

(1) A perpendicular magnetic recording medium, comprising: a substrate; a soft-magnetic underground layer formed on one main surface of said substrate; a non-magnetic layer formed on said soft-magnetic underground layer; an intermediate layer formed on said non-magnetic layer; and a perpendicular recording layer formed on said intermediate layer, wherein said intermediate layer includes a material, which includes Ru as a main constituent element and Ti as an additional element, or which includes Cu as a main constituent element and Al as an additional element.

Further in more details, preferably, the perpendicular magnetic recording medium comprises: the substrate; the soft-magnetic underground layer formed on one main surface of said substrate; the non-magnetic layer formed in contact with said soft-magnetic underground layer; the intermediate layer formed in contact with said non-magnetic layer; and the perpendicular recording layer formed in contact with said intermediate layer, in the condition thereof. Herein. “in contact with” means the condition where both layers are so position that they are substantially neighboring to each other through a boundary surface formed therebetween.

Also, preferably, in the perpendicular magnetic recording medium, said intermediate layer includes Ru as the main constituent element and Ti as the additional element, while said perpendicular recording layer includes Co and Cr and Pt as constituent elements, and concentration or density of said Cr is equal or greater than 15 at. % and futher equal or less than 25 at. %, while density of said Pt is equal or greater than 10 at. % and equal or less than 20 at. %.

(2) In the structure of the perpendicular magnetic recording medium mentioned above, said intermediate layer includes Ru as the main constituent element, and Ti as the additional element, being equal or greater than 0.14 at. % in density thereof.

Also, in the structure of the perpendicular magnetic recording medium mentioned above, said intermediate layer includes Ru as the main constituent element, and Ti as the additional element, being equal or greater than 10 at. % in density thereof.

(3) In the structure of the perpendicular magnetic recording medium mentioned above, said intermediate layer includes Cu as the main constituent element, and Al as the additional element, being equal or greater than 0.11 at. % in density thereof.

Also, in the structure of the perpendicular magnetic recording medium mentioned above, said intermediate layer includes Cu as the main constituent element, and Al as the additional element, being equal or greater than 8 at % in density thereof.

(4) A magnetic recording apparatus, comprising: a perpendicular magnetic recording medium, having a substrate, a soft-magnetic underground layer formed on one main surface of said substrate, a non-magnetic layer formed in contact with said soft-magnetic underground layer, an intermediate layer formed in contact wlth said non-magneticlayer, andaperpendicular recording layer formed in contact with said intermediate layer; a driver portion for driving said perpendicular magnetic recording medium into a recording direction; a magnetic head having a recording portion and a reproducing portion; means for moving said magnetic head in relative to said perpendicular magnetic recording medium; and a recordlng/reproducing means for conducting an input of a signal to said magnetic head and reproduction of an output signal from said magnetic head, wherein said intermediate layer includes a material, which includes Ru as a main constituent element and Ti as an additional element, or which includes Cu as a main constituent element and Al as an additional element.

Preferably, in the magnetic recording apparatus mentioned above, said perpendicular recording layer includes Co and Cr and Pt as constituent elements, and density of said Cr is equal or greater than 15 at. % and further equal or less than 25 at. %, while density of said Pt is equal or greater than 10 at. % and further equal or less than 20 at. %.

(5) In the structure of (4) of the perpendicular magnetic recording medium mentioned above, said intermediate layer includes Ru as the main constituent element, and Ti as the additional element, being equal or greater than 0.14 at. % in density thereof.

Also, in the perpendicular magnetic recording medium mentioned above, wherein said intermediate layer includes Ru as the main constituent element, and Ti as the additional element, being equal or greater than 10 at. % in density thereof.

(6) In the structure of (4) of the perpendicular magnetic recording medium mentioned above, said intermediate layer includes Cu as the main constituent element, and Al as the additional element, being equal or greater than 0.11 at. % in density thereof.

Also, in the structure of the perpendicular magnetic recording medium mentioned above, said intermediate layer includes Ru as the main constituent element, and Al as the additional element, being equal or greater than 3 at. % in density thereof.

Further, the main constituent element, herein, means an element contained therein at the most in the atomic percentage density thereof.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a cross-section view of a perpendicular magnetic recording medium, according to a first embodiment of the present invention;

FIG. 2 is a cross-section view of the perpendicular magnetic recording medium, being provided with an underground layer in an intermediate layer, according to the first embodiment of the present invention;

FIG. 3 is a view for showing a result of the relationship between addition density of Ti and depth of grain boundary groove of Ru layer, which is calculated through simulation of the molecular dynamics;

FIG. 4 is a view for showing a result of the relationship between exfoliation energy of Ru layer and the Ti addition density, which is calculated through simulation of the molecular dynamics;

FIG. 5 is a view for showing the relationship between crystal grain size on the perpendicular recording layer, which is formed on the Ru layer, and the Ti addition density;

FIG. 6 is a view for showing a result of the relationship between the addition density of Al and the depth of grain boundary groove of Cu layer, which is calculated through simulation of the molecular dynamics;

FIG. 7 is a view for showing a result of the relationship between the exfoliation energy of Cu layer and the Al addition density, which is calculated through simulation of the molecular dynamics;

FIG. 8 is a view for showing the relationship between the crystal grain size on the perpendicular recording layer, which is formed on the Cu layer, and the Ti addition density;

FIG. 9 is a cross-section view of the perpendicular magnetic recording medium, according to an embodiment of the present invention, but in case where the soft-magnetic layer is made up of so-called the one-layer structure;

FIG. 10 is a cross-section view of a perpendicular magnetic recording medium, according to a second embodiment of the present invention; and

FIG. 11 is an upper outlook view of the perpendicular magnetic recording medium, according to the second embodiment of the present.

### DETAILED DESCRIPTION OF THE INVENTION

Hereinafter, embodiments according to the present invention will be fully explained by referring to the drawings attached herewith.

### Embodiment 1

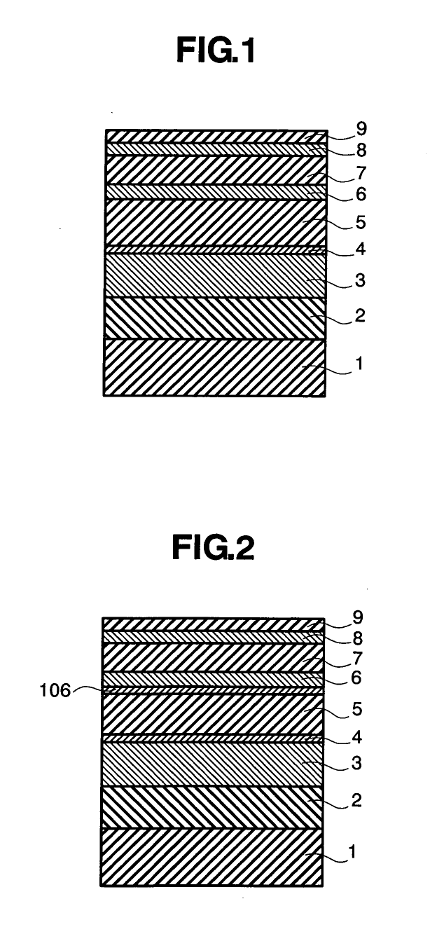

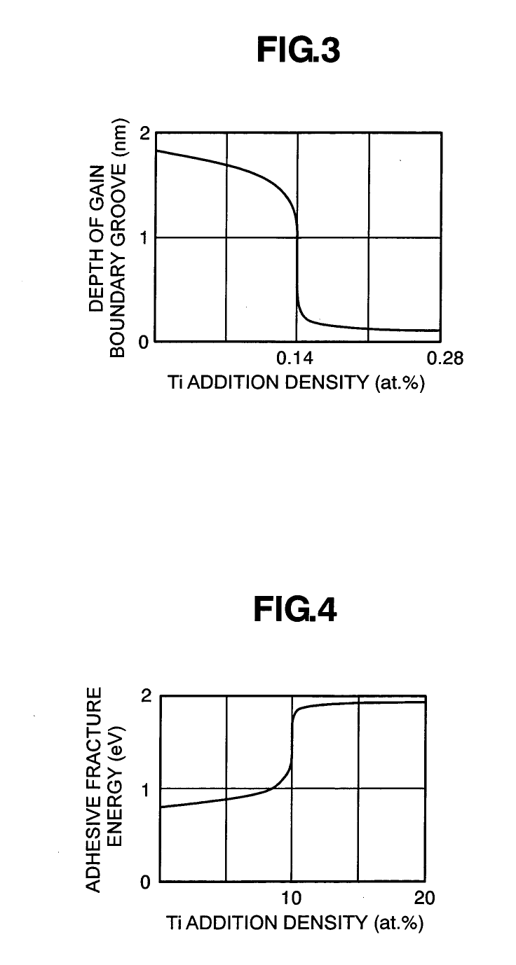

Next, first of all, the cross-sectional structure of a perpendicular magnetic recording medium is shown in FIG. 1, according to one embodiment of the present invention. As is shown in this FIG. 1, the perpendicular magnetic recording medium according to the present embodiment comprises a pre-coat layer 2 on a substrate 1, a soft-magnetic layer 3, a non-magnetic layer 4, a soft-magnetic layer 5, an intermediate layer 6, a perpendicular recording layer 7, and a protection layer 8, being formed through the DC magnetron spattering method, for example, and further thereon is formed a lubrication layer 9, in the structures thereof. The followings can be considered, as the more detailed examples of the respective layers: for example, the pre-coat layer 2 made of a CoTi film and/or a NiTi film and/or a NiTaZr film; the soft-magnetic layer 3 made of a CoZr film and/or a CoZrTa film and/or a FeTaC film, the non-magnetic layer 4 made of a Ta film and/or a Pd film and/or a Ru film, and the soft-magnetic layer 5 made of CoZ film and/or CoZrTa film and/or FeTaC film, for example. Also herein, the perpendicular recording layer is made of a perpendicular magnetic material, which has a direction of magnetization directing perpendicular to the substrate 1. As an example, there can be listed up the materials, including Co as the main constituent element, Cr added at density being equal or greater than 15 at. % and further equal or less than 25 at. %, and Pt added at density being equal or greater than 10 at. % and furhter equal or less than 20 at. %, for example. The higher on the flatness of the underground of this material, the less of the dispersion of the magnetization direction, and also the higher on, the reliability thereof. In the place of the structure shown in FIG. 1, it may be such the structure as shown in FIG. 2, in which an underground film 106 made of Ta, for example, as the intermediate layer 6. The inventors found in such the structure, that well balancing cannot be obtained between the grain boundary diffusion and the surface diffusion when the intermediate layer 6 is made of the Ru film, and therefore that the grain boundary grooves are brought about. With this grain boundary groove, the surface flatness is worsened. Then, as a result of zealous study by the inventors upon a means for improving the surface flatness, they foundthat addition of Ti into the Ru film is effectlve. Accordingly, the feature of the present embodiment lies in that the intermediate layer 6 contains Ru, as the main constituent element thereof, and also Ti, as an additional element thereof. A result obtained is shown in FIG. 3, about calculation of the relationship between addition density of Ti and depth of the gain boundary groove of Ru film, which is obtained through the molecular dynamics simulation, in particular, in the case where the intermediate layer 6 is Ru film, containing Ru as the main constituent element and having a film thickness 20 μm. From this FIG. 3, it can be seen that the depth of the gain boundary groove comes to be shallow, abruptly, when the addition density of Ti is equal to 0.14 at. % or greater than that, thereby improving the flatness. Also, FIG. 4 shows energy necessary for exfoliating that Ru film, i.e., the relationship between a result of calculation upon the adhesive fracture energy obtained through the molecular dynamics and the addition density of Ti. From this FIG. 4, it can be seen that the adhesive fracture energy comes to be large, abruptly, when the addition density of Ti is equal to 10 at. % or greater than that, thereby improving the adhesion thereof.

Further, FIG. 5 shows the relationship between crystal gain size of the perpendicular recording layer, which is formed on that Ru film and the addition density of Ti. This FIG. 5 shows a case where the perpendicular recording layer is made of the material, which includes Co, as the main constituent element thereof, Cr at the addition density being equal or greater than 15 at. % and further equal or less than 25 at. %, and Pt at the addition density being equal or greater than 10 at. % and further equal or less than 20 at. %. With this, it is possible to generate a surface strain or deformation, and thereby to form a narrow gap (i.e., a narrow pitch) on the crystal grain boundary.

In case of this material, from this FIG. 5, an effect begins to appear when the addition density of Ti comes to 6 at. % or greater than that, i.e., bringing the crystal grains to be small in the sizes thereof. And, it can be seen that the sizes of the crystal gains come down to be sufficient small (about 2 nm, in the example shown in FIG. 5), when the addition density of Ti comes up to 9 at. % or greater than that. However, disarrangement or disorder is generated in an alignment of atoms on the Ru film when exceeding 25 at/% therefore, it is preferable that the addition density of Ti is equal or lees than 25 at. %.

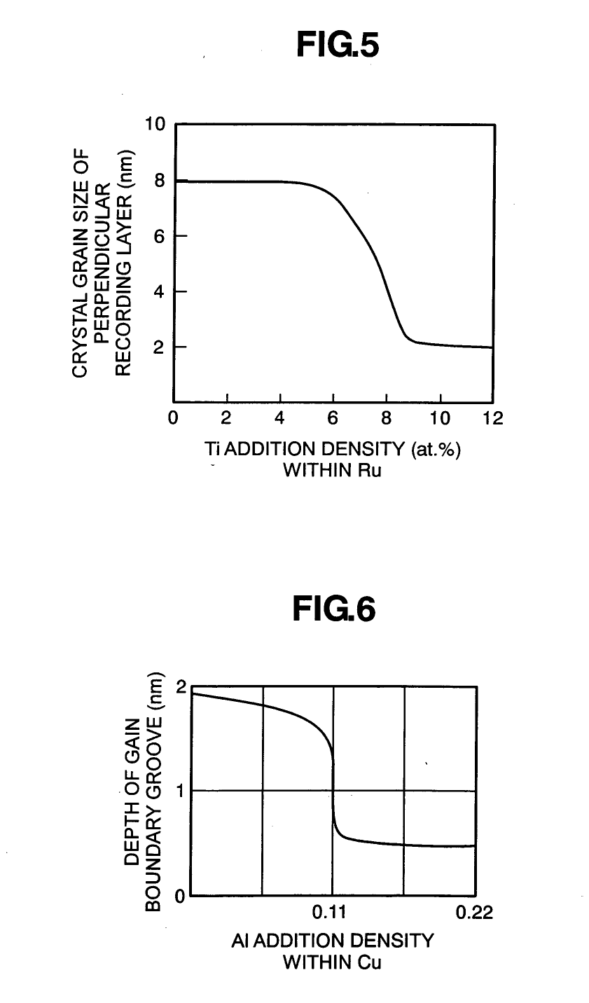

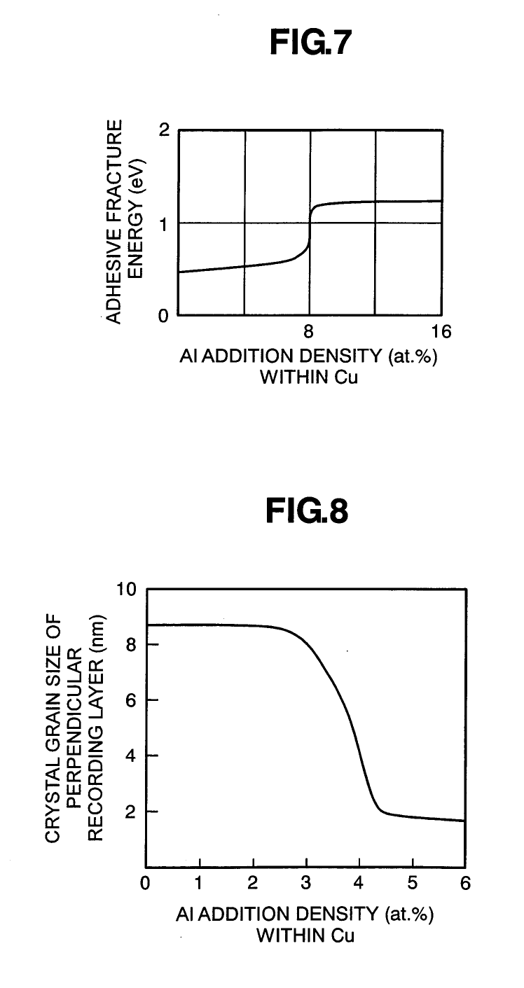

Next, FIG. 6 shows a result of calculation about a relationship between the addition density of Al and the depth of grain boundary groove on a Cu film, obtained through the molecular dynamics simulation thereof, in particular, in the case when the intermediate layer 6 is made from the Cu film, which includes Cu as the main constituent element and also has the film thickness 20 nm. From this FIG. 6, it can be seen that the depth of the grain boundary groove comes to be shallow, abruptly, when the addition density comes to 0.11 at. % or greater than that. Also, FIG. 7 shows energy necessary for exfoliating that Cu film, i.e., the relationship between a result of calculation upon the adhesive fracture energy obtained through the molecular dynamics and the addition density of Al. From this FIG. 7, it can be seen that the adhesive fracture energy comes to be large, abruptly, when the addition density of Al is equal to 8 at % or greater than that, thereby improving the adhesion.

Further, FIG. 8 shows the relationship between crystal gain size of the perpendicular recording layer, which is formed on that Cu film and the addition density of Al. This FIG. 8 shows a case where the perpendicular recording layer is made of the material, which includes Co. as the main constituent element, Cr at the addition density being equal or greater than IS at. % and further equal or less than 25 at. %, and Pt at the addition density being equal or greater than 8 at. % and further equal or less than 20 at. %. With this material, from this FIG. 8, the effect, i.e., bringing the crystal grains to be small in the sizes thereof, begins to appear when the addition density of Al comes to 3 at. % or greater than that. And, it can be seen that the sizes of the crystal gains come down to be sufficient small (about 2 nm, in the example shown in FIG. 8), when the addition density of Al comes up to 5 at. % or greater than that. However, disarrangement or disorder is generated in an alignment of atoms on the Cu film when exceeding 22 at/%; therefore, it is preferable that the addition density of Ti is equal or less than 22 at. %.

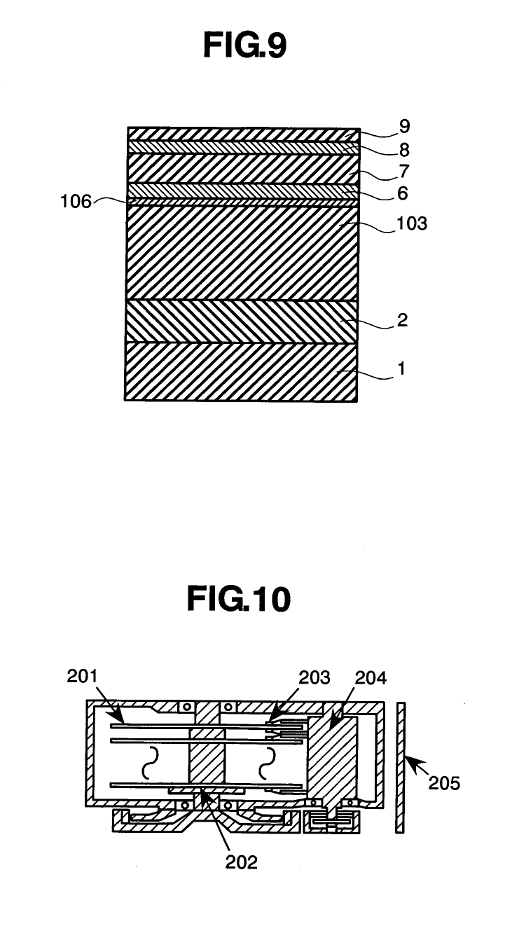

In the place of the structure shown ln FIG. 2, i.e., includlng the soft-magnetlc layer 3, the non-magnetic layer 4 and the soft-magnetic layer 5, it may be such the structure as shown in FIG. 9, i.e., using a soft-magnetic layer 103 therein. Further, the direction of magnetization can be controlled, easily, when it puts the non-magnetic layer 4 therebetween, and therefore it is preferable. Also, the elements 3, 5 and 103 may be made up with using the same material, as was mentioned above.

The effects mentioned above can be also obtained even when changing the calculation conditions of the molecular dynamics simulation.

### Embodiment 2

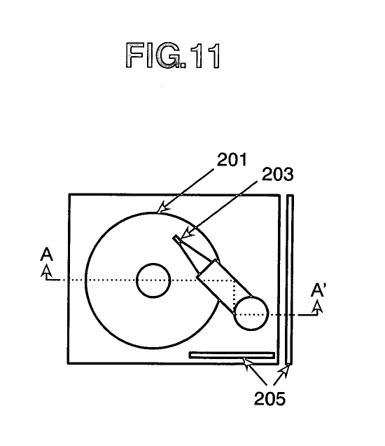

Next, an outlook view of the magnetic recording apparatus is shown in FIGS. 10 and 11, according to a second embodiment of the present invention. The magnetic recording apparatus according to the present embodiment comprises a perpendicular magnetic recording medium 201, a driver portion 202 for rotationally driving thereof, a magnetic head 203, a driver means 204 thereof, and a recording/reproducing signal processing means 205. Herein, the perpendicular magnetic recording medium 201 is of such the medium as was mentioned in the embodiment 1. Namely, the perpendicular magnetic recording medium 201 has a superiority of flatness on the film surface. If the flatness on the surface is superior, it is possible to maintain the condition of magnetic field to be flat or uniform even when floating amount of the head is equal or less than 1.0 nm, for example, and also there can be achieved an advantage of obtaining a stable performance of the magnetic recording apparatus. The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A perpendicular magnetic recording medium, comprising:
a substrate;
a soft-magnetic underground layer formed on one main surface of said substrate;
a non-magnetic layer formed on said soft-magnetic underground layer;
an intermediate layer formed on said non-magnetic layer; and
a perpendicular recording layer formed on said intermediate layer, wherein said intermediate layer includes a material, which includes Ru as a main constituent element and Ti as an additional element, or which includes Cu as a main constituent element and Al as an additional element.

2. The perpendicular magnetic recording medium, according to the claim 1, wherein said intermediate layer includes Ru as the main constituent element and Ti as the additional element, while said perpendicular recording layer includes Co and Cr and Pt as constituent elements, and density of said Cr is equal or greater than 15 at. % and further equal or less than 25 at.*, while density of said Pt is equal or greater than 10 at. % and further equal or less than 20 at. %.

3. The perpendicular magnetic recording medium, according to the claim 1, wherein said intermediate layer includes Ru as the main constituent element, and Ti as the additional element, being equal or greater than 0.14 at. % in density thereof.

4. The perpendicular magnetic recording medium, according to the claim 1, wherein said intermediate layer includes Ru as the main constituent element, and Ti as the additional element, being equal or greater than 10 at. % in density thereof.

5. The perpendicular magnetic recording medium, according to the claim 1, wherein said intermediate layer includes Cu as the main constituent element, and Al as the additional element, being equal or greater than 0.11 at. % in density thereof.

6. The perpendicular magnetic recording medium, according to the claim 1, wherein said intermediate layer includes Cu as the main constituent element, and Al as the additional element, being equal or greater than 8 at. % in density thereof.

7. A magnetic recording apparatus, comprising:
a perpendicular magnetic recording medium, hating a substrate, a soft-magnetic underground layer formed on one main surface of said substrate, a non-magnetic layer formed in contact with said soft-magnetic underground layer, an intermediate layer formed in contact with said non-magnetic layer, and a perpendicular recording layer formed in contact with said intermediate layer;
a driver portion for driving said perpendicular magnetic recording medium into a recording direction;
a magnetic head having a recording portion and a reproducing portion:
means for moving said magnetic head in relative to said perpendicular magnetic recording medium; and
a recording/reproducing means for conducting an input of a signal to said magnetic head and reproduction of an output signal from said magnetic head, wherein said intermediate layer includes a material, which includes Ru as a main constituent element and Ti as an additional element, or which includes Cu as a main constituent element and Al as an additional element.

8. The magnetic recording apparatus, according to the claim 7, wherein said perpendicular recording layer includes Co and Cr and Pt as constituent elements, and density of said Cr is equal or greater than 15 at. % and further equal or less than 25 at. %, while density of said Pt is equal or greater than 10 at. % and further equal or less than 20 at. %.

9. The perpendicular magnetic recording medium, according to the claim 7, wherein said intermediate layer includes Ru as the main constituent element, and Ti as the additional element, being equal or greater than 0.14 at. % in density thereof.

10. The perpendicular magnetic recording medium, according to the claim 7, wherein said intermediate layer includes Ru as the main constituent element, and Ti as the additional element, being equal or greater than 10 at. % in density thereof.

11. The perpendicular magnetic recording medlum, according to the claim 7, wherein said intermediate layer includes Cu as the main constituent element, and Al as the additional element, being equal or greater than 0.11 at. % in density thereof.

12. The perpendicular magneticrecordLng medium, according to the claim 7, wherein said intermediate layer includes Ru as the main constituent element, and Al as the additional element, being equal or greater than 3 at. % in density thereof.
